(19) United States
(12) Patent Application Publication
(10) Pub. No.: US 2026/0270214 A1
(43) Pub. Date: Sep. 10, 2026

(54) ELECTRONIC DEVICE

(71) Applicant: Kioxia Corporation, Tokyo (JP)

(72) Inventor: Masumi HOTTA, Fujisawa Kanagawa (JP)

(21) Appl. No.: 19/319,668

(22) Filed: Sep. 4, 2025

(30) Foreign Application Priority Data
Mar. 10, 2025 (JP) 2025-037365

(51) Int. Cl. H04L 47/10; G06F 13/42

(52) U.S. Cl. CPC H04L 47/39; G06F 13/4282; G06F 2213/0026

(57) ABSTRACT

An electronic device includes a random access memory and an interface circuit. The interface circuit executes communication between the electronic device and an external electronic device. The interface circuit stores data received from the external electronic device in the random access memory. The interface circuit manages a plurality of credit quantities respectively corresponding to a plurality of data types and each indicating a quantity of data of a corresponding data type that is currently receivable from the external electronic device. The interface circuit transmits a first packet including credit information representing at least one credit quantity among the plurality of credit quantities, to the external electronic device.

### CROSS-REFERENCE TO RELATED APPLICATION(S)

This application is based upon and claims the benefit of priority from Japanese Patent Application No. 2025-037365, filed Mar. 10, 2025, the entire contents of which are incorporated herein by reference.

### FIELD

Embodiments described herein relate generally to a technique for controlling data transmission between electronic devices.

### BACKGROUND

As one interface standard for connecting two electronic devices, the PCI Express™ (PCIe™) standard is known. The two electronic devices are connected via an interface conforming to the PCIe standard through a transmission path called a link. On the link, data is transmitted using packets.

The two electronic devices are, for example, a host and a memory system. In this case, the data transmitted using the packets includes, for example, a request from the host to the memory system, a response from the memory system to the host, or user data.

In PCIe Gen6 (PCIe 6.0 standard), a flow control unit (Flit) mode is newly defined. The Flit mode is a mode in which data is transmitted in units of packets called Flit. In the Flit mode, data received from an upper layer is decomposed and stored in Flits in units of, for example, 256 bytes, and is transmitted in units of Flits.

### BRIEF DESCRIPTION OF THE DRAWINGS

FIG. 1 is a block diagram illustrating a configuration example of an information processing system including an electronic device according to a first embodiment.

FIG. 2 is a block diagram illustrating a configuration example of the electronic device according to the first embodiment.

FIG. 3 is a diagram illustrating a configuration example of a reception credit management table used in the electronic device according to the first embodiment.

FIG. 4 is a diagram illustrating a configuration example of a transmission credit management table used in the electronic device according to the first embodiment.

FIG. 5 is a diagram illustrating an example of credit information transmitted from the electronic device according to the first embodiment to an external electronic device.

FIG. 6 is a diagram illustrating an example of a data layout of Flit used in the electronic device according to the first embodiment.

FIG. 7 is a diagram illustrating an example of a format of a data link layer packet (DLLP) payload used in the electronic device according to the first embodiment.

FIGS. 8A and 8B are diagrams illustrating an example of credit information stored in the DLLP payload in the electronic device according to the first embodiment.

FIG. 9 is a diagram illustrating another example of the credit information stored in the DLLP payload in the electronic device according to the first embodiment.

FIG. 10 is a diagram illustrating an example of a Flit transmission operation in the electronic device according to the first embodiment.

FIG. 11 is a flowchart illustrating an example of a procedure of a transmission control process executed in the electronic device according to the first embodiment.

FIG. 12 is a diagram illustrating an example of a Flit reception operation in the electronic device according to the first embodiment.

FIG. 13 is a flowchart illustrating an example of a procedure of a reception control process executed in the electronic device according to the first embodiment.

FIGS. 14A and 14B are diagrams illustrating an example of one combination of a type identifier and credit information stored in a DLLP payload in an electronic device according to a second embodiment.

FIG. 15 is a diagram illustrating an example of N combinations of a type count, type information, and the credit information stored in the DLLP payload in the electronic device according to the second embodiment.

FIG. 16 is a flowchart illustrating an example of a procedure of a transmission control process executed in the electronic device according to the second embodiment.

### DETAILED DESCRIPTION

Embodiments provide an electronic device which can efficiently transmit information related to data transmission between electronic devices.

In general, according to one embodiment, an electronic device includes a random access memory and an interface circuit. The interface circuit is configured to execute communication between the electronic device and an external electronic device, and store data received from the external electronic device in the random access memory. The interface circuit is further configured to manage a plurality of credit quantities respectively corresponding to a plurality of data types and each indicating a quantity of data of a corresponding data type that is currently receivable from the external electronic device. The interface circuit is further configured to transmit a first packet including credit information representing at least one credit quantity among the plurality of credit quantities, to the external electronic device.

Hereinafter, embodiments will be described with reference to the drawings.

### First Embodiment

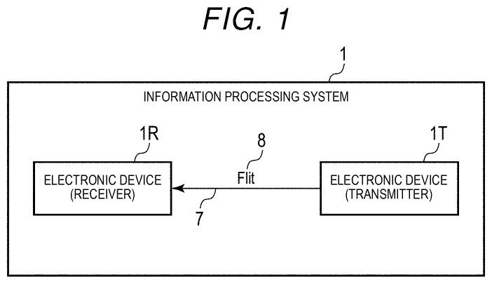

First, an example of a configuration of an information processing system including an electronic device according to a first embodiment will be described with reference to FIG. 1. An information processing system 1 is a system in which data is transmitted between an electronic device 1T and an electronic device 1R. When data transmission is performed, one of the two electronic devices 1T and 1R functions as a transmitter for transmitting data, and the other functions as a receiver for receiving the data. FIG. 1 illustrates a case where the electronic device 1T is a transmitter and the electronic device 1R is a receiver.

The electronic device 1T and the electronic device 1R are connected to each other, for example, via a serial interface including a link 7 that can interconnect them. This serial interface conforms to, for example, a standard of PCIe Gen6. The PCIe Gen6 standard defines a Flit mode. The Flit mode is a mode in which data is transmitted in units of packets called Flit. In the Flit mode, data received from an upper layer is decomposed and stored in Flits in units of, for example, 256 bytes, and is transmitted in units of Flits.

Specifically, a Flit 8 is transmitted from the electronic device 1T to the electronic device 1R via the link 7. That is, the electronic device 1T transmits the Flit 8 to the electronic device 1R via the link 7. The electronic device 1R receives the Flit 8 from the electronic device 1T via the link 7. Similarly, when the electronic device 1T is a receiver and the electronic device 1R is a transmitter, the Flit 8 may be transmitted from the electronic device 1R to the electronic device 1T via the link 7 in the same manner.

In the following, as an example, a case where the electronic device 1T is a memory system and the electronic device 1R is a host device will be specifically described.

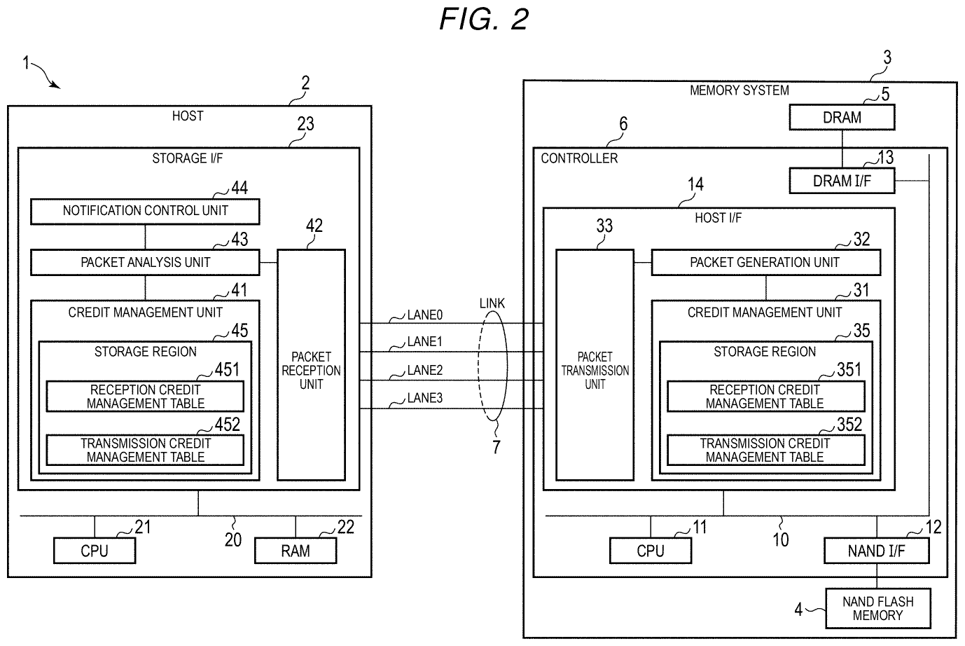

FIG. 2 is a block diagram illustrating a configuration example of a memory system and a host device.

A host device 2 is an information processing apparatus that stores data in a memory system 3. The host device 2 is, for example, a storage server or a personal computer that stores a large quantity of various data in the memory system 3. Hereinafter, the host device 2 is referred to as a host 2.

The memory system 3 is a semiconductor storage device configured to write data to a non-volatile memory and read data from the non-volatile memory. The non-volatile memory is, for example, a NAND flash memory 4. The memory system 3 is also referred to as a storage device. The memory system 3 is implemented as, for example, a solid state drive (SSD) including the NAND flash memory 4.

The memory system 3 may be used as a storage of the host 2. The memory system 3 may be connected to the host 2.

An interface for connecting the host 2 and the memory system 3 conforms to a standard such as PCIe or NVM Express™ (NVMe™).

### Configuration of Memory System 3

The memory system 3 includes, for example, the NAND flash memory 4, a dynamic random access memory (DRAM) 5, and a controller 6.

The NAND flash memory 4 includes one or more memory chips. Each of the memory chips includes a memory cell array. The memory cell array includes a plurality of blocks. Each block includes a plurality of memory cells configured to store data in a non-volatile manner. Each of the plurality of blocks functions as a minimum unit of a data erase operation. The block is also referred to as an erasing block or a physical block. Each of the plurality of blocks includes a plurality of pages. Each of the plurality of pages includes a plurality of memory cells connected to a single word line. The plurality of pages function as units of a data write operation and a data read operation, respectively. The word line may function as a unit of a data write operation and a data read operation.

The DRAM 5 is a volatile memory. A storage region of the DRAM 5 is allocated, for example, as a storage region for firmware (FW) and a cache region of a logical physical address translation table. The storage region of the DRAM 5 may be allocated as a buffer region (e.g., reception buffer) for temporarily storing data received from an outside and a buffer region (e.g., transmission buffer) for temporarily storing data to be transmitted to the outside.

The controller 6 is a memory controller that controls the NAND flash memory 4 and the DRAM 5. The controller 6 is implemented by a circuit such as a system-on-a-chip (SoC), for example.

The controller 6 includes, for example, a central processing unit (CPU) 11, a NAND interface circuit (NAND I/F) 12, a DRAM interface circuit (DRAM I/F) 13, and a host interface circuit (host I/F) 14. The CPU 11, the NAND I/F 12, the DRAM I/F 13, and the host I/F 14 may be connected via a bus 10. The controller 6 may further include a static random access memory (SRAM). The SRAM is a volatile memory. The SRAM is connected to each unit in the controller 6, for example, via the bus 10. The SRAM may store at least a part of data (information) stored in the DRAM 5 described above. For example, a storage region of the SRAM may be allocated as a reception buffer and a transmission buffer.

The CPU 11 is a processor configured to control the NAND I/F 12, the DRAM I/F 13, and the host I/F 14. The CPU 11 performs various processes by executing the FW loaded from the NAND flash memory 4 to the DRAM 5. The FW is a control program including an instruction group for causing the CPU 11 to execute various processes. The process includes a command process for processing various commands from the host 2. An operation of the CPU 11 is controlled by the FW executed by the CPU 11. The functions of each unit in the controller 6 may be implemented by dedicated hardware in the controller 6, may be implemented by the CPU 11 executing the FW, or may be implemented by a combination thereof.

The NAND I/F 12 electrically connects the controller 6 and the NAND flash memory 4. The NAND I/F 12 conforms to an interface standard such as a toggle double data rate (toggle DDR) or an open NAND flash interface (ONFI).

The NAND I/F 12 functions as a NAND control circuit configured to control the NAND flash memory 4. The NAND I/F 12 may be connected to a plurality of memory chips in the NAND flash memory 4 via a plurality of channels. The plurality of memory chips are driven in parallel, so that an access bandwidth between the NAND flash memory 4 and the controller 6 can be increased.

The DRAM I/F 13 functions as a DRAM control circuit configured to control access to the DRAM 5.

The host I/F 14 is a circuit that functions as an interface for communication between the memory system 3 and the host 2 (that is, an external electronic device). The host I/F 14 includes a circuit for transmitting a packet to the host 2 and a circuit for receiving a packet from the host 2. The packet is, for example, a packet conforming to the PCIe standard. The packet includes, for example, a command, a response, or user data. The command is, for example, an input and output (I/O) command or a control command. The I/O command is, for example, a read command or a write command. The control command is, for example, an unmap command (trim command).

The host I/F 14 includes, for example, a credit management unit 31, a packet generation unit 32, and a packet transmission unit 33, as circuits for transmitting packets to the host 2.

The credit management unit 31 is a circuit that manages credits for data transmission via the link 7 by the memory system 3 and the host 2 for each type. The credit is an index based on which flow control (FC) is performed in data transmission. For example, when the memory system 3 and the host 2 conform to the PCIe standard, the credit is of six types including: Posted Request headers (PH), Posted Request Data payload (PD), Non-Posted Request headers (NPH), Non-Posted Request Data payload (NPD), Completion headers (CplH), and Completion Data payload (CplD). The flow control is control for preventing overflow of a reception buffer in the electronic device 1R (here, the host 2) on a reception side and performing data transmission in accordance with the credit by the electronic device 1T (here, the memory system 3) on a transmission side.

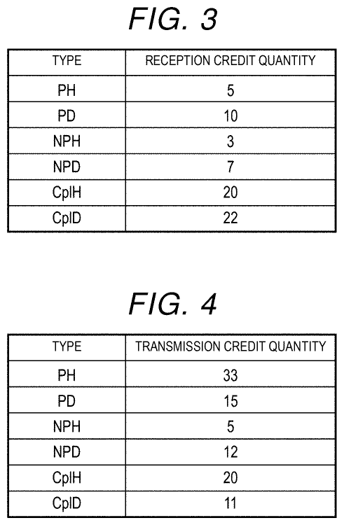

The credit management unit 31 includes a storage region 35. The storage region 35 is configured in, for example, an SRAM. For example, a reception credit management table 351 and a transmission credit management table 352 are stored in the storage region 35. The reception credit management table 351 is a table for managing a credit quantity indicating a receivable data quantity from the outside (here, the host 2), for each type. The credit quantity indicating the receivable data quantity from the outside is also referred to as a reception credit quantity. The transmission credit management table 352 is a table for managing a credit quantity indicating a transmissible data quantity to the outside, for each type. The credit quantity indicating the transmissible data quantity to the outside is also referred to as a transmission credit quantity. A specific configuration example of the reception credit management table 351 and the transmission credit management table 352 will be described below with reference to FIGS. 3 and 4.

The credit management unit 31 manages the reception credit quantity for each type, by using the reception credit management table 351. Specifically, when communication with the host 2 is started, the credit management unit 31 determines an initial value of the reception credit quantity for each type based on a storage capacity of a reception buffer allocated to each type of a plurality of types of credits, and manages the initial value. The credit management unit 31 manages the current reception credit quantity for each type based on an available capacity of the reception buffer corresponding to each type. The current reception credit quantity for a certain type is, for example, a credit quantity that has changed from the initial value of the reception credit quantity for that type, in accordance with reception of data from the host 2 and the processing of that data.

For example, when data is newly stored in the reception buffer corresponding to a certain type, the credit management unit 31 updates the current reception credit quantity for that type by subtracting a credit quantity based on a quantity of the stored data from the current reception credit quantity for that type. When data is discarded from the reception buffer corresponding to a certain type, the credit management unit 31 updates the current reception credit quantity for that type by adding a credit quantity based on a quantity of the discarded data to the current reception credit quantity for that type.

In addition, the credit management unit 31 manages the transmission credit quantity for each type by using the transmission credit management table 352. Specifically, when communication with the host 2 is started, the credit management unit 31 manages an initial value of the transmission credit quantity (that is, the reception credit quantity in the host 2) for each type notified by the host 2 as the initial value of the transmission credit quantity for each type. The credit management unit 31 updates the current transmission credit quantity for that type based on a change amount (increase or decrease) for the certain type of credit notified by the host 2. That is, the current transmission credit quantity for a certain type is, for example, a credit quantity that has changed from the initial value of the transmission credit quantity for that type, in accordance with transmission of data to the host 2 and the processing of that data by the host 2.

For example, when a consumption quantity of transmission credit for a certain type is notified by the host 2, the credit management unit 31 updates the current transmission credit quantity for that type, by subtracting the notified consumption quantity from the current transmission credit quantity for that type managed by the credit management unit 31. When a recovery quantity of transmission credit for a certain type is notified by the host 2, the credit management unit 31 updates the current transmission credit quantity for that type by adding the notified recovery quantity to the current transmission credit quantity for that type managed by the credit management unit 31.

The packet generation unit 32 is a circuit that generates a packet to be transmitted to the host 2. The packet is, for example, the Flit 8. For example, when the CPU 11 requests transmission of data to the host 2, the packet generation unit 32 generates the Flit 8 including at least a part of the data. The data for which transmission is requested may include data used in a transaction with the host 2. The packet generation unit 32 may generate the Flit 8 further including information representing the current reception credit quantity for each type, in cooperation with the credit management unit 31. The information representing the current reception credit quantity for each type is also referred to as credit information. The packet generation unit 32 sends the generated Flit 8 to the packet transmission unit 33.

The packet transmission unit 33 is a circuit connected to the host 2 via a serial interface. The serial interface includes the link 7 that can interconnect the host 2 and the memory system 3. The packet transmission unit 33 corresponds to, for example, a physical layer (PCIe PHY) defined in the PCIe standard. The packet transmission unit 33 has, for example, a physical connection format conforming to the PCIe standard. The packet transmission unit 33 performs an interface operation of physically transmitting data via the link 7. Specifically, the packet transmission unit 33 transmits, for example, the Flit 8, which is received from the packet generation unit 32, to the host 2 via the link 7.

The link 7 is configured with a plurality of lanes. Each of the plurality of lanes includes a signal line for a signal transmitted from the host 2 to the memory system 3 and a signal line for a signal transmitted from the memory system 3 to the host 2. FIG. 2 illustrates the link 7 configured with four lanes of lane0, lane1, lane2, and lane3, as an example.

With the above configuration, the memory system 3 manages and controls data transmission with the host 2.

### Configuration of Host 2

The host 2 includes, for example, a CPU 21, a random access memory (RAM) 22, and a storage interface circuit (storage I/F) 23. The CPU 21, the RAM 22, and the storage I/F 23 may be connected via a bus 20.

The CPU 21 is a processor configured to control the RAM 22 and the storage I/F 23. The CPU 21 performs various processes by executing a program loaded in the RAM 22, for example. The program executed by the CPU 21 includes, for example, an operating system, a device driver, and an application program. The process by the CPU 21 includes a process of issuing a command to the memory system 3 and a process of receiving a response to the command. The operation of the CPU 21 is controlled by the program executed by the CPU 21. The function of each unit in the host 2 may be implemented by dedicated hardware in the host 2, may be implemented by the CPU 21 executing a program, or may be implemented by a combination thereof.

The RAM 22 is a volatile memory. A storage region of the RAM 22 is allocated, for example, as a storage region for a program. The storage region of the RAM 22 may be allocated as a buffer region (e.g., reception buffer) for temporarily storing data received from an outside and a buffer region (e.g., transmission buffer) for temporarily storing data to be transmitted to the outside.

The storage I/F 23 is a circuit that functions as an interface for communication between the host 2 and the memory system 3 (that is, an external electronic device). The storage I/F 23 includes a circuit for transmitting a packet to the memory system 3 and a circuit for receiving a packet from the memory system 3.

The storage I/F 23 includes, for example, a credit management unit 41, a packet reception unit 42, a packet analysis unit 43, and a notification control unit 44, as circuits for receiving packets from the memory system 3.

The credit management unit 41 is a circuit that manages credits for data transmission via the link 7 by the host 2 and the memory system 3 for each type. The credit management unit 41 includes a storage region 45. The storage region 45 is configured in, for example, an SRAM. For example, a reception credit management table 451 and a transmission credit management table 452 are stored in the storage region 45. The reception credit management table 451 is a table for managing a credit quantity (reception credit quantity) indicating a receivable data quantity from an outside (here, the memory system 3), for each type. The transmission credit management table 452 is a table for managing a credit quantity (transmission credit quantity) indicating a transmissible data quantity to the outside, for each type.

The credit management unit 41 manages the reception credit quantity for each type, by using the reception credit management table 451. Specifically, when communication with the memory system 3 is started, the credit management unit 41 determines an initial value of the reception credit quantity for each type based on a storage capacity of a reception buffer allocated to each type of a plurality of types of credits, and manages the initial value. The credit management unit 41 manages the current reception credit quantity for each type based on an available capacity of the reception buffer corresponding to each type. The current reception credit quantity for a certain type is, for example, a credit quantity that is changed from the initial value of the reception credit quantity for that type, in accordance with reception of data from the memory system 3 and the processing of that data.

For example, when data is newly stored in the reception buffer corresponding to a certain type, the credit management unit 41 updates the current reception credit quantity for that type by subtracting a credit quantity based on a quantity of the stored data from the current reception credit quantity for that type. When data is discarded from the reception buffer corresponding to a certain type, the credit management unit 41 updates the current reception credit quantity for that type by adding a credit quantity based on a quantity of the discarded data to the current reception credit quantity for that type.

In addition, the credit management unit 41 manages the transmission credit quantity for each type by using the transmission credit management table 452. Specifically, when communication with the memory system 3 is started, the credit management unit 41 manages an initial value of the transmission credit quantity (that is, the reception credit quantity in the memory system 3) for each type notified by the memory system 3 as the initial value of the transmission credit quantity for each type. The credit management unit 41 updates the current transmission credit quantity for that type based on a change amount of the credit for the certain type notified by the memory system 3. That is, the current transmission credit quantity for a certain type is, for example, a credit quantity that has changed from the initial value of the transmission credit quantity for that type, in accordance with transmission of data to the memory system 3 and the processing of that data by the memory system 3.

For example, when a consumption quantity of transmission credit for a certain type is notified by the memory system 3, the credit management unit 41 updates the current transmission credit quantity for that type, by subtracting the notified consumption quantity from the current transmission credit quantity for that type managed by the credit management unit 41. When a recovery quantity of transmission credit for a certain type is notified by the memory system 3, the credit management unit 41 updates the current transmission credit quantity for that type by adding the notified recovery quantity to the current transmission credit quantity for that type managed by the credit management unit 41.

The packet reception unit 42 is a circuit connected to the memory system 3 via a serial interface (more specifically, the link 7). The packet reception unit 42 corresponds to, for example, a physical layer defined in the PCIe standard. The packet reception unit 42 has, for example, a physical connection format conforming to the PCIe standard. The packet reception unit 42 performs an interface operation of physically receiving data via the link 7. Specifically, the packet reception unit 42 receives the Flit 8 from the memory system 3 via, for example, the link 7. The packet reception unit 42 sends the received Flit 8 to the packet analysis unit 43.

The packet analysis unit 43 is a circuit that analyzes the Flit 8 received from the packet reception unit 42. Specifically, the packet analysis unit 43 performs an error detection and correction process on data included in the Flit 8. When no error is detected or when the detected error is corrected, a process using the data included in the Flit 8 is performed. Specifically, the data in the Flit 8, which is used in the transaction in the host 2, is processed by, for example, the storage I/F 23 and the CPU 21. In addition, when credit information representing a reception credit quantity in the memory system 3 is included in the Flit 8, the packet analysis unit 43 may determine whether the credit information corresponds to a transmission credit quantity managed by the credit management unit 41, for each type. For example, the packet analysis unit 43 compares the credit information with the transmission credit quantity managed by the credit management unit 41 for each type. That is, the packet analysis unit 43 may determine whether the transmission credit quantity for the memory system 3 is correctly managed in the transmission credit management table 452, based on the credit information representing the reception credit quantity for each type in the memory system 3. The packet analysis unit 43 sends a determination result for each type to the notification control unit 44.

The notification control unit 44 controls a notification (output) based on the determination result received from the packet analysis unit 43. Specifically, the notification control unit 44 outputs an error, for example, when the credit information in the Flit 8 does not correspond to the transmission credit quantity managed by the transmission credit management table 452 for a certain type. The notification control unit 44 may output information indicating whether the credit information in the Flit 8 corresponds to the transmission credit quantity managed by the transmission credit management table 452 for each type. Alternatively, the notification control unit 44 may output information indicating a type for which the credit information and the transmission credit quantity do not correspond to each other.

With the above configuration, the host 2 manages and controls data transmission with the memory system 3.

The host I/F 14 of the memory system 3 further includes the same configuration as the packet reception unit 42, the packet analysis unit 43, and the notification control unit 44. That is, the host I/F 14 can receive the Flit 8 including the credit information for each type, analyze the Flit 8, and output in accordance with the analysis result, in the same manner as the storage I/F 23 described above. Hereinafter, the configuration provided in the host I/F 14 in the same manner as the packet reception unit 42, the packet analysis unit 43, and the notification control unit 44 is simply referred to as the packet reception unit 42, the packet analysis unit 43, and the notification control unit 44 of the host I/F 14.

In addition, the storage I/F 23 of the host 2 further includes the same configuration as the packet generation unit 32 and the packet transmission unit 33. That is, the storage I/F 23 can transmit the Flit 8 including the credit information for each type in the same manner as the host I/F 14 described above. Hereinafter, the configuration provided in the storage I/F 23 in the same manner as the packet generation unit 32 and the packet transmission unit 33 is simply referred to as the packet generation unit 32 and the packet transmission unit 33 of the storage I/F 23.

Here, a configuration of each of the reception credit management table 351 and the transmission credit management table 352 will be described.

FIG. 3 illustrates a configuration example of the reception credit management table 351. The reception credit management table 351 includes a plurality of entries corresponding to a plurality of types of credits, respectively. Each of the plurality of entries includes a type field and a reception credit quantity field.

The type field indicates information capable of uniquely identifying the corresponding type. The information capable of uniquely identifying a type is, for example, a name of the type. Specifically, for example, any of PH, PD, NPH, NPD, CplH, and CplD defined in the PCIe standard is set in the type field.

The reception credit quantity field indicates a data quantity (reception credit quantity) of the corresponding type, which can be currently received from the host 2. The reception credit quantity is indicated by, for example, the number of data units according to the type. For example, a reception credit quantity of PH is indicated by the number of data units corresponding to PH, which can be currently received from the host 2.

In the example illustrated in FIG. 3, the reception credit quantity of PH is 5. This means that the host I/F 14 can currently receive 5 PHs from the host 2. Further, the reception credit quantity of PD is 10. The reception credit quantity of NPH is 3. The reception credit quantity of NPD is 7. The reception credit quantity of CplH is 20. The reception credit quantity of CplD is 22.

With the above configuration, the host I/F 14 can manage the reception credit quantity for each type in the memory system 3, by using the reception credit management table 351.

The reception credit management table 451 in the host 2 has, for example, the same configuration as the reception credit management table 351. Therefore, the storage I/F 23 of the host 2 can manage the reception credit quantity for each type in the host 2 by using the reception credit management table 451.

FIG. 4 illustrates a configuration example of the transmission credit management table 352. The transmission credit management table 352 includes a plurality of entries corresponding to a plurality of types of credits, respectively. Each of the plurality of entries includes a type field and a transmission credit quantity field.

The type field indicates information capable of uniquely identifying the corresponding type.

The transmission credit quantity field indicates a data quantity (transmission credit quantity) for the corresponding type, which can be currently transmitted to the host 2. The transmission credit quantity is indicated by, for example, the number of data units according to the type. For example, a transmission credit quantity of PH is indicated by the number of data units corresponding to PH, which can be currently transmitted to the host 2.

In the example illustrated in FIG. 4, the transmission credit quantity of PH is 33. This means that the host I/F 14 can currently transmit 33 PHs to the host 2. Further, the transmission credit quantity of PD is 15. The transmission credit quantity of NPH is 5. The transmission credit quantity of NPD is 12. The transmission credit quantity of CplH is 20. The transmission credit quantity of CplD is 11.

With the above configuration, the host I/F 14 can manage the transmission credit quantity for each type in the memory system 3 by using the transmission credit management table 352.

The transmission credit management table 452 in the host 2 has, for example, the same configuration as the transmission credit management table 352. Therefore, the storage I/F 23 of the host 2 can manage the transmission credit quantity for each type in the host 2 by using the transmission credit management table 452.

Next, credit information transmitted from the memory system 3 to the host 2 will be described. As described above, the credit information transmitted from the memory system 3 to the host 2 represents the current reception credit quantity for each type in the memory system 3.

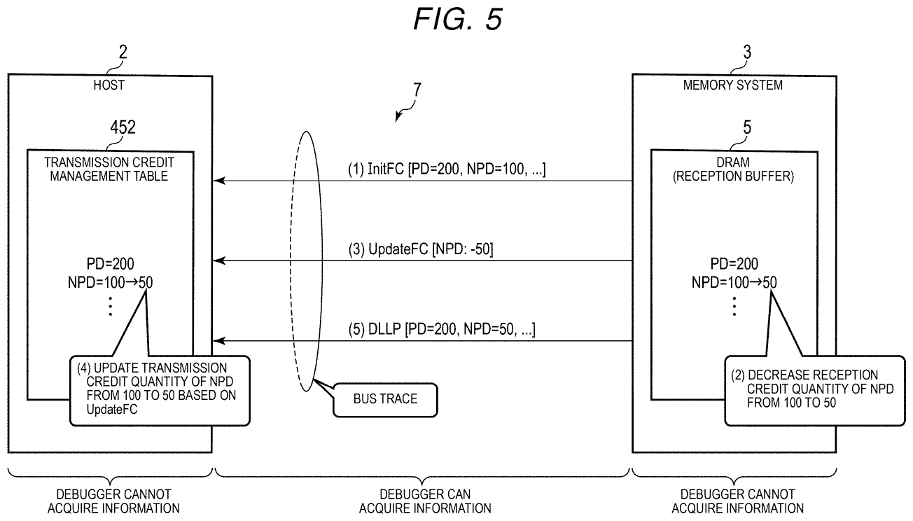

FIG. 5 illustrates an example of the credit information transmitted from the memory system 3 to the host 2. Here, a case where the DRAM 5 is used as a reception buffer for receiving data from the host 2 via the link 7 in the memory system 3 will be described. In addition, in the DRAM 5, it is assumed that the initial value of the reception credit quantity of PD is 200 and the initial value of the reception credit quantity of NPD is 100. In FIG. 5, description of reception credit quantities for the other types is omitted, but the reception credit quantity for each type is managed, for example, in the reception credit management table 351 in the memory system 3.

First, the memory system 3 transmits information (initial value information) indicating the initial value of the reception credit quantity for each type to the host 2 via the link 7 using InitFC, which is one of data link layer packets (DLLP), as seen (1) in FIG. 5. The InitFC including the initial value information is transmitted immediately after a training process of the link 7 in initialization (that is, an initialization sequence) between the host I/F 14 and the storage I/F 23 is completed. Specifically, the memory system 3 notifies the host 2 that, in the InitFC, for example, the initial value of the reception credit quantity of PD is 200 and the initial value of the reception credit quantity of NPD is 100. The DLLP is used, for example, for transmitting information related to flow control between electronic devices.

The host 2 receives the initial value information from the memory system 3. The host 2 manages the initial value of the reception credit quantity for each type based on the received initial value information, by using the transmission credit management table 452. That is, the host 2 sets the transmission credit quantity of PD to 200 and sets the transmission credit quantity of NPD to 100 in the transmission credit management table 452.

Here, it is assumed that data, by which the credit quantity of NPD is consumed by 50, is transmitted from the host 2 to the memory system 3. In this case, in the memory system 3, the reception credit quantity of NPD is reduced from 100 to 50 (see (2) in FIG. 5). The memory system 3 transmits information (update information) indicating that the reception credit quantity of NPD is consumed by 50 to the host 2 via the link 7 using UpdateFC which is one of the DLLPs (see (3) in FIG. 5). The memory system 3 may notify the host 2 that the reception credit quantity of NPD is consumed by a total of 50, by transmitting a plurality of UpdateFCs in accordance with the progress of the reception of the data from the host 2. The plurality of transmitted UpdateFCs include, for example, update information indicating that the reception credit quantity of NPD is consumed by 20, and update information indicating that the reception credit quantity of NPD is consumed by 30. In the UpdateFC, update information indicating a recovered quantity of the reception credit quantity may be transmitted. That is, the update information indicates a change amount of the reception credit quantity (that is, any of the consumption quantity and the recovery quantity).

The host 2 receives one or more pieces of update information indicating that the reception credit quantity of NPD is consumed by a total of 50 from the memory system 3 by one or more UpdateFCs. The host 2 updates the transmission credit management table 452 to indicate that the transmission credit quantity of NPD is 50 (=100−50) based on the received one or more pieces of update information (see (4) in FIG. 5).

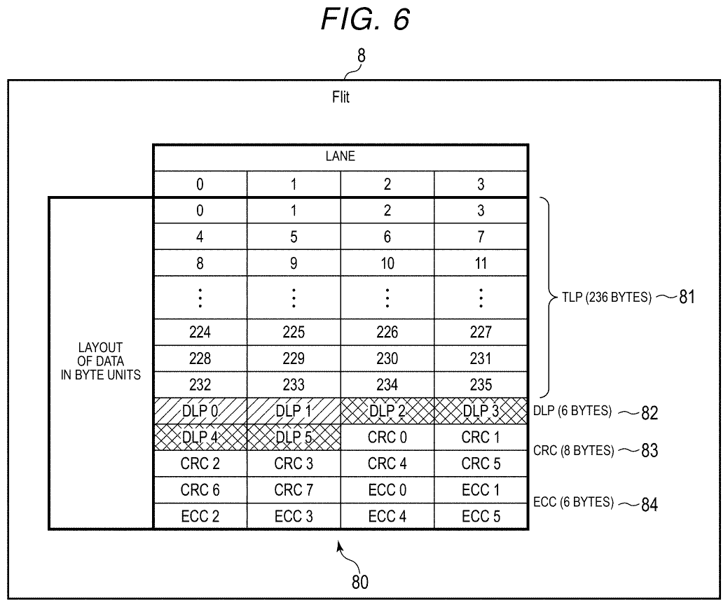

Thereafter, the memory system 3 transmits the Flit 8 including credit information indicating that the current reception credit quantity of PD is 200 and credit information indicating that the current reception credit quantity of NPD is 50 to the host 2 via the link 7 (see (5) in FIG. 5). The credit information is stored in, for example, a DLLP payload included in the Flit 8. A specific method of transmitting the Flit 8 including the credit information will be described below with reference to FIGS. 6 to 11.

The host 2 receives credit information for each type from the memory system 3. For example, by using the received credit information for each type and the transmission credit quantity for each type indicated in the transmission credit management table 452, the host 2 may determine whether the transmission credit quantity for each type is correctly managed in the transmission credit management table 452. When the reception credit quantity for a certain type represented by the received credit information does not correspond to (or does not coincide with) the transmission credit quantity for the same type indicated in the transmission credit management table 452, the host 2 determines that there is an error in the transmission credit quantity for the type managed by the host 2.

In this manner, the memory system 3 transmits initial value information, update information, and credit information related to the reception credit quantity for each type to the host 2 via the link 7. The host 2 manages the transmission credit quantity for each type based on the initial value information, the update information, and the credit information received from the memory system 3 by using the transmission credit management table 452.

The current reception credit quantity for each type in the DRAM 5 (e.g., reception buffer) of the memory system 3 is information that can be acquired inside the memory system 3, but is difficult for a debugger of the information processing system 1 to acquire. Further, the current transmission credit quantity for each type managed in the transmission credit management table 452 of the host 2 is information that can be acquired inside the host 2, but is difficult for a debugger to acquire.

The debugger is an operator who analyzes performance, a failure, and the like in data transmission between the host 2 and the memory system 3. The debugger can acquire the initial value information, the update information, and the credit information transmitted via the link 7, for example, by using a bus trace for the link 7. When the debugger acquires the initial value information and all the update information transmitted by the memory system 3, the debugger can calculate the current reception credit quantity in the memory system 3. In other words, when the debugger does not acquire the initial value information or any update information, the debugger cannot acquire the current reception credit quantity.

In the PCIe standard (for example, PCIe 6.x standard) that has been developed so far, it is specified that the initial value information (InitFC) and the update information (UpdateFC) are to be transmitted, but it is not specified that the credit information is to be transmitted. In addition, in the standard of PCIe 7.x or later under development, it may similarly not be specified that the credit information is to be transmitted.

The memory system 3 according to the present embodiment transmits not only the initial value information and the update information but also the credit information. Therefore, the debugger can acquire the current reception credit quantity in the memory system 3 for each type only by acquiring the credit information. Therefore, for example, when performance of data transmission (more specifically, packet transmission) from the host 2 to the memory system 3 is reduced, the debugger may determine whether the cause is exhaustion of the reception credit quantity or an internal process of the memory system 3. In addition, when, for example, a failure occurs such as the host 2 managing an incorrect credit quantity as the current reception credit quantity in the memory system 3, the debugger may recognize the occurrence of the failure. In this manner, the debugger can easily analyze the performance, the failure, and the like of the data transmission from the host 2 to the memory system 3 by using the credit information. Therefore, by transmitting the credit information, the memory system 3 can improve debugging efficiency of the debugger.

Furthermore, the same applies, with reference to FIG. 5, to the case where the host 2 transmits the initial value information, the update information, and the credit information related to the reception credit quantity for each type to the memory system 3.

A specific method of transmitting the Flit 8 including the credit information will be described with reference to FIGS. 6 to 11.

FIG. 6 illustrates an example of a data layout of the Flit 8. Here, a case where the size of the Flit 8 is 256 bytes and the Flit 8 is transmitted by using the four lanes of lane 0 to lane 3 in the link 7 will be described.

The Flit 8 includes 256 data sections 80 in byte units. The 256 data sections 80 are data sections 80 from the 0-th to the 255-th. In the Flit 8, the 256 data sections 80 are disposed such that 4 data sections 80 are transmitted with the four lanes of lane0 to lane3, for each of the four data sections 80 from the head.

The data sections 80 of 236 bytes from the 0-th to 235-th constitute a transaction layer packet (TLP) 81. The TLP 81 is a packet for transmitting data of a transaction layer. The data of the transaction layer is, for example, data used in a transaction in an electronic device as a transmission destination (for example, the host 2 or the memory system 3).

The data sections 80 of 6 bytes following the TLP 81 (that is, the data sections 80 from the 236-th to the 241-th) constitute a data layer packet (DLP) 82. As illustrated in FIG. 6, the data sections 80 of 6 bytes constituting the DLP 82 are also referred to as DLP0 to DLP 5. The DLP 82 is a packet for transmitting data of a data link layer. The data of the data link layer includes, for example, data for supporting management of the link 7.

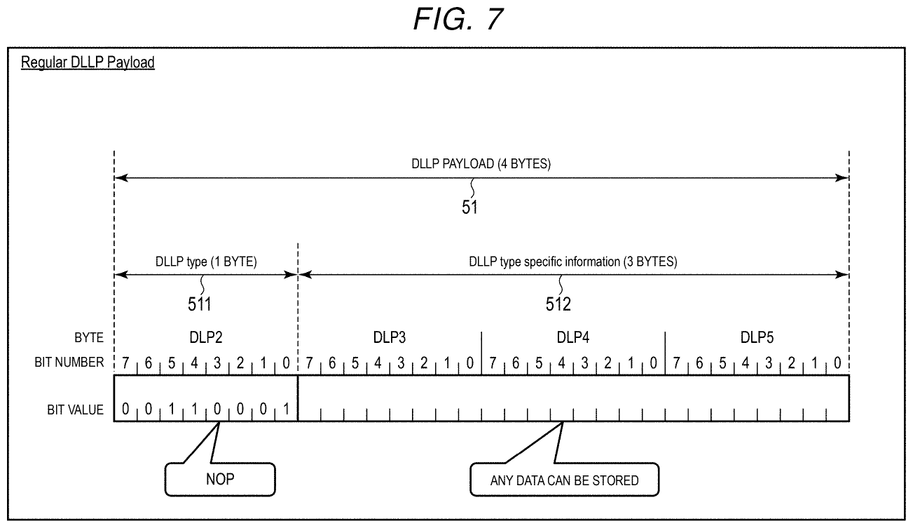

Specifically, for example, information for designating a type of the DLLP payload is stored in DLP0 and DLP1. The type of the DLLP payload is, for example, any of Regular DLLP Payload, Optimized Update FC DLLP Payload, and Flit Marker DLLP Payload. DLP2 to DLP5 correspond to the DLLP payload. A specific configuration of the DLLP payload will be described below with reference to FIG. 7.

The data sections 80 of 8 bytes following the DLP 82 (that is, the data sections 80 from the 242-th to the 249-th) constitute a cyclic redundancy check (CRC) code 83. In FIG. 6, the data sections 80 of 8 bytes constituting the CRC code 83 are denoted as CRC0 to CRC7. The CRC code 83 is a CRC code for the TLP 81 and the DLP 82. Hereinafter, the CRC code 83 is simply referred to as a CRC 83.

The data sections 80 of 6 bytes following the CRC code 83 (that is, the data section 80 from the 250-th to the 255-th) constitute an error correction code (ECC) 84. In FIG. 6, the data sections 80 of 6 bytes constituting the ECC 84 are denoted as ECC0 to ECC5. The ECC 84 is an ECC for the TLP 81, the DLP 82, and the CRC 83.

Based on such a data layout, for example, the Flit 8 is generated and the Flit 8 is analyzed. The data layout of the Flit 8 illustrated in FIG. 6 is an example. The data layout of the Flit 8 may be changed according to the number of lanes used for transmission of the Flit 8, for example.

In the Flit 8, the DLLP payload may be used as Regular DLLP Payload. Further, when No Operation (NOP) is designated as a type of DLLP used as Regular DLLP Payload, a value indicating NOP is set in the data section 80 of one byte at the head (DLP2) of the 4-byte DLLP payload, and the following data sections 80 of 3 bytes (DLP3 to DLP 5) become a region in which any data can be stored.

When there is no data to be transmitted with a DLLP payload, for example, NOP is designated as the type of the DLLP. In this case, for example, any data is stored in the following data sections 80 of 3 bytes.

Therefore, the electronic devices 1T and 1R according to the present embodiment are configured to store any data in the following data sections 80 of 3 bytes by designating NOP as the type of the DLLP when there is no data to be transmitted with the DLLP payload. Therefore, the data sections 80 of 3 bytes in the DLLP payload can be effectively used.

FIG. 7 illustrates an example of a format of a DLLP payload used as Regular DLLP Payload. As described above with reference to FIG. 6, a DLLP payload 51 of 4 bytes corresponds to DLP2 to DLP5 included in the Flit 8. The DLLP payload 51 includes a 1-byte DLLP type 511 (DLP2) and 3-byte DLLP type specific information 512 (DLP3 to DLP5).

The DLLP type 511 is a region in which a bit string indicating a type of the DLLP payload 51 is set. For example, when NOP is designated as the type of the DLLP payload 51, the bit string “00110001” is set in the DLLP type 511.

The DLLP type specific information 512 is a region in which information corresponding to the DLLP type 511 is set. When NOP is designated for the DLLP type 511, any data can be stored in the DLLP type specific information 512.

In the information processing system 1, credit information is transmitted between the electronic device 1T and the electronic device 1R by using the DLLP type specific information 512 in the DLLP payload 51 in which NOP is designated in the DLLP type 511. Specifically, for example, the credit information is transmitted from the memory system 3 to the host 2. In addition, for example, the credit information is transmitted from the host 2 to the memory system 3.

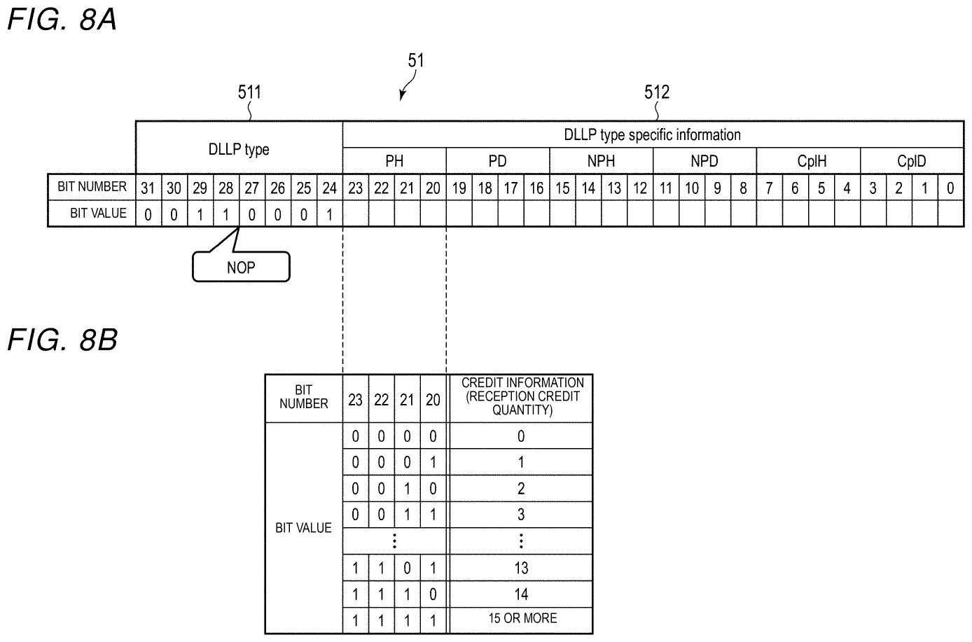

FIGS. 8A and 8B illustrate an example of the credit information stored in the DLLP payload 51. In FIGS. 8A and 8B, the data sections 80 of 4 bytes constituting the DLLP payload 51 is illustrated as a bit string from bit #31 to bit #0. A bit string of 8 bits from bit #31 to bit #24 corresponds to the DLLP type 511. A bit string of 24 bits from bit #23 to bit #0 corresponds to the DLLP type specific information 512.

The value “00110001” for designating NOP is set in the DLLP type 511.

For example, a plurality of pieces of credit information respectively corresponding to a plurality of types of credits are set in the DLLP type specific information 512. Specifically, the bit string from bit #23 to bit #0 is divided into a plurality of partial bit strings (data sections) to set the plurality of pieces of credit information. The plurality of pieces of credit information are stored (set) in a plurality of partial bit strings, respectively. The credit information represents a current reception credit quantity for a corresponding type.

In the example illustrated in FIG. 8A, the plurality of types of credits are six types of PH, PD, NPH, NPD, CplH, and CplD. The bit string from bit #23 to bit #0 is divided into six partial bit strings each having a bit length of 4 bits to store six pieces of credit information respectively corresponding to the six types.

A partial bit string from bit #23 to bit #20 is assigned to credit information of PH. A partial bit string from bit #19 to bit #16 is assigned to credit information of PD. A partial bit string from bit #15 to bit #12 is assigned to credit information of NPH. A partial bit string from bit #11 to bit #8 is assigned to credit information of NPD. A partial bit string from bit #7 to bit #4is assigned to credit information of CplH. A partial bit string from bit #3 to bit #0 is assigned to credit information of CplD.

Here, the credit information of PH stored as the partial bit string from bit #23 to bit #20 will be described. The partial bit string from bit #23 to bit #20 is referred to as a PH bit string. The same is applied to the other partial bit strings described above.

FIG. 8B illustrates an example of the credit information of PH stored as the PH bit string. The bit length of the PH bit string is 4 bits. Therefore, the PH bit string can represent the reception credit quantity of PH in 16 (=2⁴) stages.

Specifically, for example, the PH bit string “0000” indicates that the reception credit quantity is 0. The PH bit string “0001” indicates that the reception credit quantity is 1. The PH bit string “0010” indicates that the reception credit quantity is 2. The PH bit string “0011” indicates that the reception credit quantity is 3. In the same manner, the PH bit string “1101” indicates that the reception credit quantity is 13. The PH bit string “1110” indicates that the reception credit quantity is 14. The PH bit string “1111” indicates that the reception credit quantity is 15 or more.

A format of the DLLP type specific information 512 used for transmitting the credit information (hereinafter, also referred to as a format of the credit information) is shared in advance between the memory system 3 and the host 2. Specifically, the format of the credit information is shared, for example, in a training process of the link 7 in initialization of the host I/F 14 and the storage I/F 23. That is, the format of the credit information is shared in the training process before reaching the link power state L0, which is a normal operation state (active state). The format of the credit information includes, for example, a disposition of bit strings for each type in the DLLP type specific information 512, and a correspondence relationship between values of the bit strings for each type and the reception credit quantity. The host I/F 14 and the storage I/F 23 store information indicating the format of the credit information in, for example, Ordered Set used in the training process. Alternatively, new Ordered Set for storing information indicating the format of the credit information may be defined. In either way, the host I/F 14 and the storage I/F 23 can share the format of the credit information based on Ordered Set in the training process.

The PH bit string may represent any 16-stage reception credit quantity without being limited to the example illustrated in FIG. 8B.

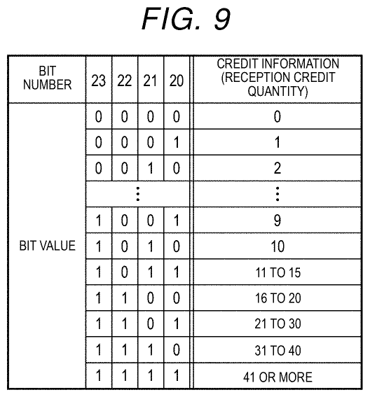

FIG. 9 illustrates another example of the credit information represented by the PH bit string. Here, the PH bit string is used to represent the reception credit quantity when the reception credit quantity of PH is equal to or less than a threshold value, and is used to represent a range including the reception credit quantity when the reception credit quantity exceeds the threshold value. The threshold value can be set to any value. The range including the reception credit quantity is, for example, a range from a credit quantity P to a credit quantity Q or a range equal to or more than the credit quantity P. Here, P is an integer of 0 or larger, and Q is an integer larger than P.

In the example illustrated in FIG. 9, the threshold value is 10. Therefore, when the reception credit quantity is any one of 0 to 10, the PH bit string represents the reception credit quantity. When the reception credit quantity is 11 or more, the PH bit string represents a range including the reception credit quantity.

Specifically, for example, the PH bit string “0000” indicates that the reception credit quantity is 0. The PH bit string “0001” indicates that the reception credit quantity is 1. The PH bit string “0010” indicates that the reception credit quantity is 2. In the same manner, the PH bit string “1001” indicates that the reception credit quantity is 9. The PH bit string “1010” indicates that the reception credit quantity is 10. In this manner, when the reception credit quantity is 10 or less, the PH bit string represents the reception credit quantity.

For example, the PH bit string “1011” indicates that the reception credit quantity is within a range from 11 to 15. The PH bit string “1100” indicates that the reception credit quantity is within a range from 16 to 20. The PH bit string “1101” indicates that the reception credit quantity is within a range from 21 to 30. The PH bit string “1110” indicates that the reception credit quantity is within a range from 31 to 40. The PH bit string “1111” indicates that the reception credit quantity is in a range of 41 or more. In this manner, when the reception credit quantity exceeds 10, the PH bit string represents a range including the reception credit quantity. The larger the reception credit quantity, the larger the range including the reception credit quantity may be set. For example, the range from 21 to 30 (i.e., the range width is 9) indicating a reception credit quantity of 21 is larger than the range from 11 to 15 (i.e., the range width is 4) indicating a reception credit quantity of 11. The width of the range including the reception credit quantity may be set to be the same regardless of a size of the reception credit quantity, except for a range including a specific value or more of the reception credit quantity (in FIG. 9, a range including 41 or more of the reception credit quantity).

In the same manner as the PH bit string, each of a PD bit string, an NPH bit string, an NPD bit string, a CplH bit string, and a CplD bit string can also represent the reception credit quantity for the corresponding type in 16 stages.

The storage of the credit information in the DLLP payload 51 is an example. The credit information may be stored in any region in the Flit 8 that does not affect the storage of data to be transmitted to the host 2. Alternatively, the DLLP payload 51 may store any information other than the credit information. The information stored in the DLLP payload 51 may be any information indicating the current state of any quantity indicating a state of the internal resources of the memory system 3, such as the credit quantity, of which state (for example, the amount, the number, and the like) is managed by the controller 6 (more specifically, the host I/F 14) based on an initial value information and update information.

### Flit Transmission Operation

Next, a Flit transmission operation will be described. The Flit transmission operation is an operation for transmitting the Flit 8 including credit information representing the current reception credit quantity to an external electronic device. Here, a case where the memory system 3 transmits the Flit 8 to the host 2 will be described.

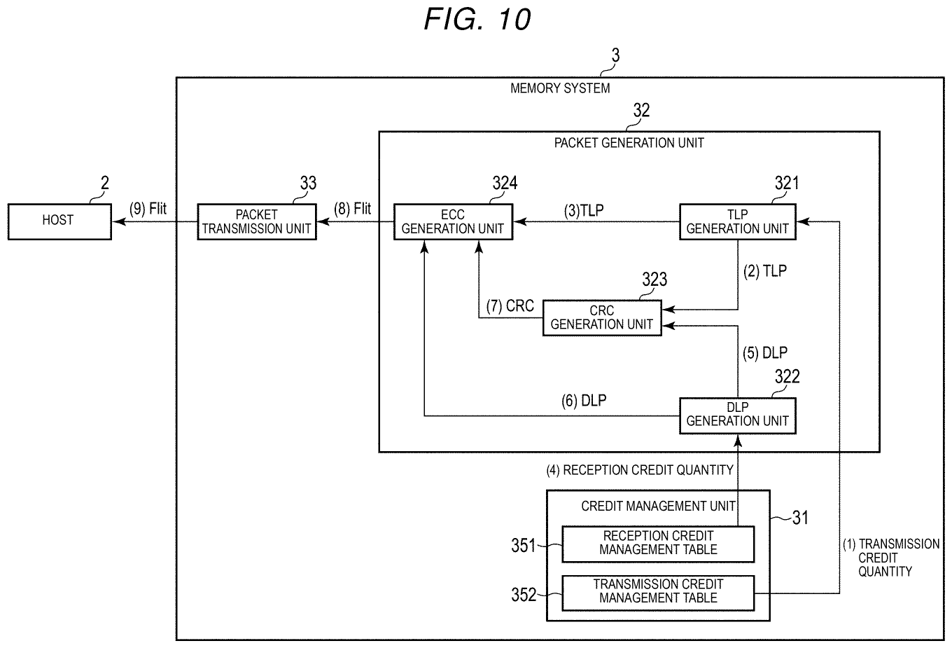

FIG. 10 illustrates an example of a Flit transmission operation in the memory system 3. The Flit transmission operation is performed by the credit management unit 31, the packet generation unit 32, and the packet transmission unit 33. The credit management unit 31 manages each of the reception credit quantity for each type and the transmission credit quantity for each type, by using the reception credit management table 351 and the transmission credit management table 352. The packet generation unit 32 includes, for example, a TLP generation unit 321, a DLP generation unit 322, a CRC generation unit 323, and an ECC generation unit 324.

The TLP generation unit 321 determines, for each type, whether the TLP 81 including data of a transaction layer to be transmitted (hereinafter, also referred to as target data) can be transmitted to the host 2 by using the transmission credit quantity for each type acquired from the transmission credit management table 352 (see (1) in FIG. 10). Specifically, the TLP generation unit 321 calculates a credit quantity consumed to transmit the target data (that is, a credit quantity consumed by the host 2 to receive the target data) for each type. The credit quantity consumed to transmit the target data is also referred to as a first credit consumption quantity. The TLP generation unit 321 acquires the transmission credit quantity for each type from the transmission credit management table 352. The TLP generation unit 321 determines whether the first credit consumption quantity is equal to or less than the transmission credit quantity for all types. When the first credit consumption quantity for a certain type is equal to or less than the transmission credit quantity, the TLP generation unit 321 determines that the TLP 81 including the target data and corresponding to the type can be transmitted to the host 2. On the other hand, when the first credit consumption quantity for a certain type exceeds the transmission credit quantity, the TLP generation unit 321 determines that the TLP 81 including the target data and corresponding to the type cannot be transmitted to the host 2. Hereinafter, a case where the TLP 81 including the target data can be transmitted to the host 2 will be described.

The TLP generation unit 321 generates the TLP 81 including the target data. The TLP generation unit 321 sends the generated TLP 81 to the CRC generation unit 323 and the ECC generation unit 324 (see (2) and (3) in FIG. 10).

Next, the DLP generation unit 322 acquires the current reception credit quantity for each type from the reception credit management table 351 (see (4) in FIG. 10). The DLP generation unit 322 generates the DLP 82 including information (credit information) for representing the current reception credit quantity for each type. In the DLP 82, the Regular DLLP Payload is designated as a type of the DLLP payload. In addition, the DLP 82 includes the DLLP payload 51. The DLLP payload 51 includes the DLLP type 511 in which NOP is designated and the DLLP type specific information 512 in which the credit information for each type is stored. The DLP generation unit 322 sends the generated DLP 82 to the CRC generation unit 323 and the ECC generation unit 324 (see (5) and (6) in FIG. 10).

The CRC generation unit 323 generates the CRC 83 for the TLP 81 and the DLP 82. For example, a predetermined generation polynomial is used to generate the CRC 83. The CRC generation unit 323 sends the generated CRC 83 to the ECC generation unit 324 (see (7) in FIG. 10).

The ECC generation unit 324 generates the ECC 84 for the TLP 81, the DLP 82, and the CRC 83. The ECC generation unit 324 sends the Flit 8 including the TLP 81, the DLP 82, the CRC 83, and the ECC 84 to the packet transmission unit 33 (see (8) in FIG. 10).

The packet transmission unit 33 transmits the Flit 8 to the host 2 via the link 7 (see (9) in FIG. 10).

With the above Flit transmission operation, the memory system 3 transmits the Flit 8 including the credit information for each type to the host 2. Therefore, the host 2 can acquire the credit information for each type from the received Flit 8.

The Flit transmission operation in the same manner is performed in the host 2. That is, the host 2 transmits the Flit 8 including credit information for each type to the memory system 3. Therefore, the memory system 3 can acquire the credit information for each type from the received Flit 8.

The credit information for each type is stored in the DLP 82, which is a partial region of the Flit 8. More specifically, the credit information for each type is stored in the DLLP type specific information 512 in the DLLP payload 51 when there is no data to be transmitted as, for example, the DLLP payload 51. Therefore, in the information processing system 1, the credit information is transmitted without a bandwidth of the link 7 being overloaded and without consuming extra resources. Therefore, the credit information can be efficiently transmitted between the memory system 3 and the host 2.

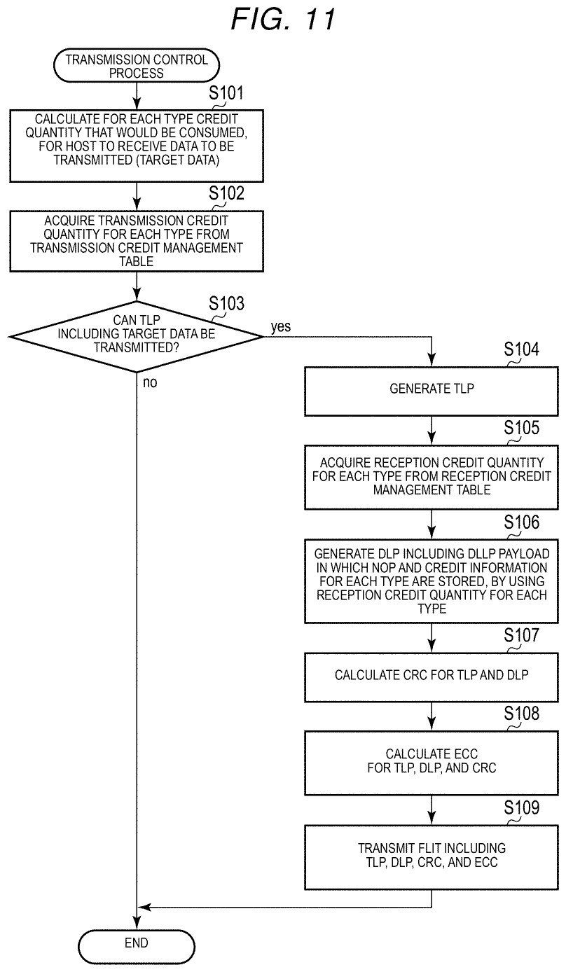

FIG. 11 is a flowchart illustrating an example of a procedure of a transmission control process executed in the memory system 3. The transmission control process is a process for transmitting the Flit 8 including credit information representing the current reception credit quantity to an external electronic device (here, the host 2). The host I/F 14 of the memory system 3 executes the transmission control process at a time at which, for example, the Flit 8 (more specifically, the TLP 81) is to be transmitted. Here, it is assumed that NOP can be designated as a type of the DLLP in the DLLP payload 51 in the Flit 8 to be transmitted.

First, in step S101, the host I/F 14 calculates, for each type, a credit quantity (first credit consumption quantity) that would be consumed for the host 2 to receive data of a transaction layer to be transmitted (target data). The host I/F 14 acquires the transmission credit quantity for each type from the transmission credit management table 352 (step S102). The host I/F 14 determines whether the TLP 81 including the target data can be transmitted to the host 2, based on the first credit consumption quantity for each type and the transmission credit quantity for each type (step S103). Specifically, the host I/F 14 determines whether the first credit consumption quantity is equal to or less than the transmission credit quantity for all types.

When the TLP 81 including the target data cannot be transmitted to the host 2 (no in step S103), the host I/F 14 ends the transmission control process. That is, when the first credit consumption quantity for a certain type exceeds the transmission credit quantity, the host I/F 14 determines that the Flit 8 that includes the TLP 81 including the target data and corresponding to the type cannot be transmitted to the host 2, and ends the transmission control process.

When the TLP 81 including the target data can be transmitted to the host 2 (yes in step S103), the host I/F 14 generates the TLP 81 including the target data (step S104).

Next, the host I/F 14 acquires the reception credit quantity for each type from the reception credit management table 351 (step S105). Specifically, the host I/F 14 acquires, for example, the reception credit quantity of each of PH, PD, NPH, NPD, CplH, and CplD from the reception credit management table 351. The host I/F 14 generates the DLP 82 including the DLLP payload 51 in which NOP and credit information for each type are stored, by using the acquired reception credit quantity for each type (step S106). More specifically, the host I/F 14 generates the DLLP payload 51 including (1) the DLLP type 511 in which NOP is designated and (2) the DLLP type specific information 512 in which a plurality of pieces of credit information respectively representing the reception credit quantities for all types are stored.

The host I/F 14 calculates the CRC 83 for the generated TLP 81 and DLP 82 (step S107). The host I/F 14 calculates the ECC 84 for the generated TLP 81, the DLP 82, and the calculated CRC 83 (step S108). The host I/F 14 transmits the Flit 8 including the TLP 81, the DLP 82, the CRC 83, and the ECC 84 to the host 2 via the link 7 (step S109), and ends the transmission control process.

With the above transmission control process, when the TLP 81 including the target data can be transmitted, the host I/F 14 transmits the credit information representing the current reception credit quantity for each type to the host 2 by using the DLLP payload 51 in the Flit 8. The host I/F 14 can transmit the credit information to the host 2 without a bandwidth of the link 7 being overloaded and without consuming extra resources, by using the DLLP payload 51, which is a partial region of the Flit 8. Therefore, the host I/F 14 can efficiently transmit the credit information to the host 2.

In addition, the transmission control process in the same manner may be executed by the storage I/F 23 of the host 2. In this case, the transmission credit management table 352 used in step S102 is replaced with the transmission credit management table 452 in the host 2, and the reception credit management table 351 used in step S105 is replaced with the reception credit management table 451 in the host 2. Therefore, the storage I/F 23 transmits the credit information representing the current reception credit quantity for each type to the memory system 3, by using the DLLP payload 51 in the Flit 8. The storage I/F 23 can transmit the credit information to the memory system 3 without a bandwidth of the link 7 being overloaded and without consuming extra resources, by using the DLLP payload 51, which is a partial region of the Flit 8. Therefore, the storage I/F 23 can efficiently transmit the credit information to the memory system 3.

### Flit Reception Operation

Next, a Flit reception operation will be described. The Flit reception operation is an operation for receiving the Flit 8 including credit information representing the current reception credit quantity from an external electronic device. Here, a case where the host 2 receives the Flit 8 from the memory system 3 will be described.

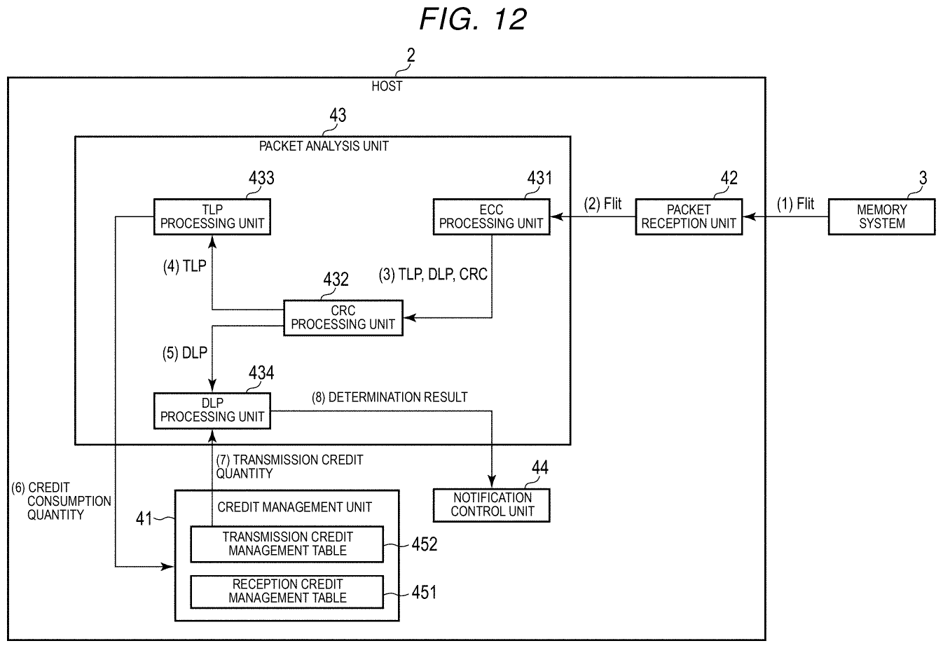

FIG. 12 illustrates an example of a Flit reception operation in the host 2. The Flit reception operation is performed by the credit management unit 41, the packet reception unit 42, the packet analysis unit 43, and the notification control unit 44. The credit management unit 41 manages each of the reception credit quantity for each type and the transmission credit quantity for each type, by using the reception credit management table 451 and the transmission credit management table 452. The packet analysis unit 43 includes, for example, an ECC processing unit 431, a CRC processing unit 432, a TLP processing unit 433, and a DLP processing unit 434.

First, the packet reception unit 42 receives the Flit 8 from the memory system 3 (see (1) in FIG. 12). The packet reception unit 42 sends the received Flit 8 to the ECC processing unit 431 (see (2) in FIG. 12).

The ECC processing unit 431 acquires the TLP 81, the DLP 82, the CRC 83, and the ECC 84 from the Flit 8 received from the packet reception unit 42. The ECC processing unit 431 performs an error detection and correction process on the TLP 81, the DLP 82, and the CRC 83, by using the ECC 84. When an error is not detected or a detected error is corrected in the error detection and correction process, the ECC processing unit 431 sends the TLP 81, the DLP 82, and the CRC 83 on which the error detection and correction process is performed to the CRC processing unit 432 (see (3) in FIG. 12). In the error detection and correction process, when an error is detected and the detected error cannot be corrected, the ECC processing unit 431 may request the memory system 3 to retransmit the Flit 8.

The CRC processing unit 432 receives the TLP 81, the DLP 82, and the CRC 83 on which the error detection and correction process is performed from the ECC processing unit 431. The CRC processing unit 432 performs an error detection process on the TLP 81 and the DLP 82, by using the CRC 83. When an error is not detected in the error detection process, the CRC processing unit 432 sends the TLP 81 to the TLP processing unit 433 (see (4) in FIG. 12), and sends the DLP 82 to the DLP processing unit 434 (see (5) in FIG. 12). In the error detection process, when an error is detected, the CRC processing unit 432 may request the memory system 3 to retransmit the Flit 8.

The TLP processing unit 433 receives the TLP 81 from the CRC processing unit 432. The TLP processing unit 433 performs a process according to data included in the TLP 81. Specifically, the TLP processing unit 433 stores the TLP 81 in the RAM 22 (reception buffer). The TLP processing unit 433 sends information indicating a credit quantity (credit consumption quantity) for each type, which is consumed in accordance with the reception (storage) of the TLP 81, to the credit management unit 41 (see (6) in FIG. 12). The TLP processing unit 433 may send information capable of specifying the consumed credit quantity for each type to the credit management unit 41. The information capable of specifying the consumed credit quantity for each type is information indicating a type of the TLP 81. The type of the TLP 81 includes, for example, a memory read, a memory write, an input and output (I/O) read, an I/O write, a configuration read, a configuration write, a message without data, a message with data, and various types of completions.

The credit management unit 41 receives the information indicating the credit consumption quantity in accordance with the reception of the TLP 81 from the TLP processing unit 433. The credit management unit 41 updates the reception credit management table 451 based on the received information. Specifically, when the received information indicates the credit consumption quantity for a certain type, the credit management unit 41 identifies an entry corresponding to the type in the reception credit management table 451. The credit management unit 41 updates the credit quantity indicated in the identified entry to a value obtained by subtracting the credit consumption quantity from the current value.

Alternatively, the credit management unit 41 may update the reception credit management table 451, in accordance with an increase or decrease in data for each type stored in the reception buffer (for example, RAM 22). In this case, the credit management unit 41 may not receive the information indicating the credit consumption quantity in accordance with the reception of the TLP 81 from the TLP processing unit 433.

The DLP processing unit 434 receives the DLP 82 from the CRC processing unit 432. The DLP processing unit 434 acquires the credit information for each type included in the DLP 82. In addition, the DLP processing unit 434 acquires the transmission credit quantity for each type from the transmission credit management table 452 (see (7) in FIG. 12). The DLP processing unit 434 determines for each type, whether the credit information and the transmission credit quantity correspond to each other.

Specifically, when the credit information represents a credit quantity, the DLP processing unit 434 determines whether the credit quantity coincides with the transmission credit quantity. Further, when the credit information represents a range including the credit quantity, the DLP processing unit 434 determines whether the transmission credit quantity is included in the range. When the transmission credit quantity is included in the range, the DLP processing unit 434 determines that the credit quantity represented by the credit information and the transmission credit quantity coincide with each other. When the transmission credit quantity is not included in the range, the DLP processing unit 434 determines that the credit quantity represented by the credit information does not coincide with the transmission credit quantity.

The DLP processing unit 434 sends a determination result for each type indicating whether the credit information and the transmission credit quantity correspond to each other, to the notification control unit 44 (see (8) in FIG. 12).

The notification control unit 44 performs a notification based on the determination result received from the DLP processing unit 434. Specifically, the notification control unit 44 outputs an error, for example, when the credit information and the transmission credit quantity do not correspond to each other for a certain type. The notification control unit 44 may notify an external party (for example, a debugger) of information indicating whether the credit information and the transmission credit quantity correspond to each other for each type. Alternatively, the notification control unit 44 may notify the external party of information indicating the type for which the credit information and the transmission credit quantity do not correspond to each other.

When there is a type for which the credit information and the transmission credit quantity do not correspond to each other, the DLP processing unit 434 may send the type of credit information to the credit management unit 41. The credit management unit 41 may update (modify) the entry of the corresponding type in the transmission credit management table 452, by using the credit information received from the DLP processing unit 434.

With the above Flit reception operation, the host 2 receives the Flit 8 including the credit information for each type from the memory system 3. The host 2 can check whether the transmission credit quantity for each type with respect to the memory system 3 (that is, the reception credit quantity for each type in the memory system 3) is correctly managed in the transmission credit management table 452, by using the credit information for each type.

The Flit reception operation in the same manner is performed in the memory system 3. That is, the memory system 3 receives the Flit 8 including the credit information for each type from the host 2. The memory system 3 can check whether, for example, the transmission credit quantity for each type with respect to the host 2 (that is, the reception credit quantity for each type in the host 2) is correctly managed in the transmission credit management table 352, by using the credit information for each type.

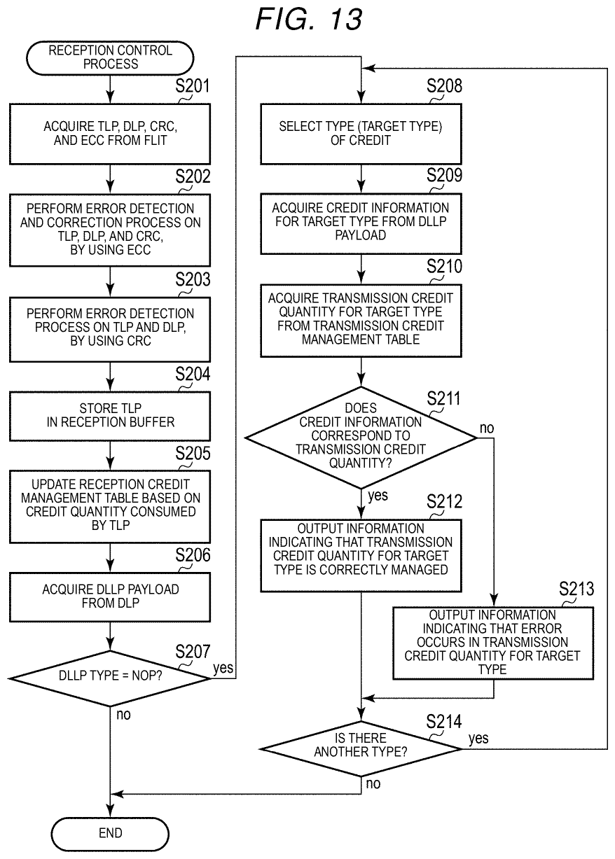

FIG. 13 is a flowchart illustrating an example of a procedure of a reception control process executed by the host 2. The reception control process is a process in accordance with the Flit 8 received from the memory system 3. The storage I/F 23 of the host 2 executes the reception control process in accordance with the reception of the Flit 8 from the memory system 3 via the link 7.

First, the storage I/F 23 acquires the TLP 81, the DLP 82, the CRC 83, and the ECC 84 from the received Flit 8 (step S201). The storage I/F 23 performs an error detection and correction process on the TLP 81, the DLP 82, and the CRC 83, by using the acquired ECC 84 (step S202). Here, it is assumed that no error is detected or the detected error is corrected in the error detection and correction process.

Next, the storage I/F 23 performs an error detection process on the TLP 81 and the DLP 82, by using the CRC 83 (step S203). Here, it is assumed that an error is not detected in the error detection process.

The storage I/F 23 stores the TLP 81 in a reception buffer (step S204). The reception buffer is, for example, a part of a storage region of the RAM 22. For example, a process of a transaction layer is performed by the CPU 21 in accordance with the TLP 81 stored in the reception buffer.

In addition, the storage I/F 23 updates the reception credit management table 451 based on a credit quantity consumed by storing the TLP 81 in the reception buffer (step S205). Specifically, the storage I/F 23 determines, for example, a type and the consumption quantity of credits consumed by the TLP 81. The storage I/F 23 subtracts the determined consumption quantity from the reception credit quantity in an entry in the reception credit management table 451 corresponding to the determined type.

Next, the storage I/F 23 acquires the DLLP payload 51 from the DLP 82 (step S206). The storage I/F 23 determines whether the DLLP type is NOP, by using the acquired DLLP payload 51 (step S207). That is, the storage I/F 23 determines whether a bit string indicating NOP is set in the DLLP type 511 in the DLLP payload 51.

When the DLLP type is not NOP (no in step S207), the storage I/F 23 ends the reception control process. The storage I/F 23 may process the DLLP payload 51 including the DLLP type other than NOP in accordance with the DLLP type.

When the DLLP type is NOP (yes in step S207), the storage I/F 23 selects one type (hereinafter, referred to as a target type) from a plurality of types of credits (step S208). The storage I/F 23 acquires the credit information for the target type from the DLLP payload 51 (step S209). The credit information for the target type represents a data quantity (reception credit quantity of the memory system 3) by which the TLP 81 including data of the target type can be currently received by the memory system 3 from the host 2. Specifically, the storage I/F 23 acquires a bit string from a region in the DLLP payload 51 corresponding to the target type. The storage I/F 23 acquires the credit information for the target type, based on the acquired bit string. The credit information represents the credit quantity or a range of the credit quantity.

The storage I/F 23 acquires the transmission credit quantity for the target type from the transmission credit management table 452 (step S210). That is, the storage I/F 23 acquires a data quantity by which the host 2 can currently transmit the TLP 81 including data of the target type to the memory system 3 (transmission credit quantity of the host 2). The storage I/F 23 determines whether the credit information acquired from the DLLP payload 51 corresponds to the transmission credit quantity of the host 2, for the target type (step S211). Specifically, when the credit information indicates the credit quantity, the storage I/F 23 determines whether the credit quantity is equal to the transmission credit quantity of the host 2. In addition, when the credit information indicates a range of the credit quantity, the storage I/F 23 determines whether the transmission credit quantity of the host 2 is within the range of the credit quantity.

When the credit information corresponds to the transmission credit quantity of the host 2 (yes in step S211), the storage I/F 23 outputs information indicating that the transmission credit quantity for the target type is correctly managed in the transmission credit management table 452 (step S212). Specifically, the storage I/F 23 notifies an external party of, for example, that the transmission credit quantity for the target type is correctly managed. The storage I/F 23 may omit the output indicating that the transmission credit quantity for the target type is correctly managed. The process by the storage I/F 23 proceeds to step S214.

When the credit information does not correspond to the transmission credit quantity of the host 2 (no in step S211), the storage I/F 23 outputs information indicating that an error occurs in the transmission credit quantity for the target type (step S213). Specifically, the storage I/F 23 notifies the external party that an error occurs in the transmission credit quantity for the target type. Alternatively, the storage I/F 23 may replace the transmission credit quantity set in the entry in the transmission credit management table 452 corresponding to the determined type with the reception credit quantity indicated in the credit information. The process by the storage I/F 23 proceeds to step S214.

Next, the storage I/F 23 determines whether there is another type of credit that is unprocessed (step S214).

When there is another type of credit that is unprocessed (yes in step S214), the process by the storage I/F 23 returns to step S208. That is, the storage I/F 23 processes credit information in the DLLP payload 51 and a transmission credit quantity of the host 2, for another credit type.

When the process for all the credit types is completed (no in step S214), the storage I/F 23 ends the reception control process.

With the above reception control process, the storage I/F 23 performs the process according to the Flit 8 received from the memory system 3. Specifically, when the DLLP payload 51 in which NOP is designated is included in the Flit 8, the storage I/F 23 acquires credit information representing the current reception credit quantity for each type in the memory system 3. The storage I/F 23 can acquire the credit information without a bandwidth of the link 7 being overloaded and without consuming the resources excessively, by using the DLLP payload 51, which is a partial region of the Flit 8. Therefore, the storage I/F 23 can acquire the credit information efficiently transmitted from the memory system 3.

The reception control process in the same manner may be executed by the host I/F 14 of the memory system 3. In this case, the reception credit management table 451 used in step S205 is replaced with the reception credit management table 351 in the memory system 3, and the transmission credit management table 452 used in step S210 is replaced with the transmission credit management table 352 in the memory system 3. Therefore, when the DLLP payload 51 in which NOP is designated is included in the Flit 8, the host I/F 14 acquires credit information representing the current reception credit quantity for each type in the host 2. The host I/F 14 can acquire the credit information without a bandwidth of the link 7 being overloaded and without consuming extra resources, by using the DLLP payload 51, which is a partial region of the Flit 8. Therefore, the host I/F 14 can acquire the credit information efficiently transmitted from the host 2.

### Second Embodiment

In the first embodiment, the Flit 8 including the credit information for all types is transmitted between the electronic devices.

In contrast, in a second embodiment, the Flit 8 including the credit information for at least one type among all types is transmitted between the electronic devices. In other words, in the second embodiment, the credit information for all types are transmitted across a plurality of the Flit 8.

Configurations of the electronic devices 1T and 1R (for example, the memory system 3 and the host 2) according to the second embodiment are the same as the configurations of the electronic devices 1T and 1R according to the first embodiment. Between the second embodiment and the first embodiment, methods of storing information related to a credit in the DLLP payload 51 in the Flit 8 are different. Hereinafter, the points different from the first embodiment will be mainly described.

In each of the memory system 3 and the host 2, the packet generation unit 32 (more specifically, the DLP generation unit 322) is configured to store, for example, one combination of a type identifier and credit information in the DLLP payload 51. The type identifier is information capable of uniquely identifying a corresponding credit type.

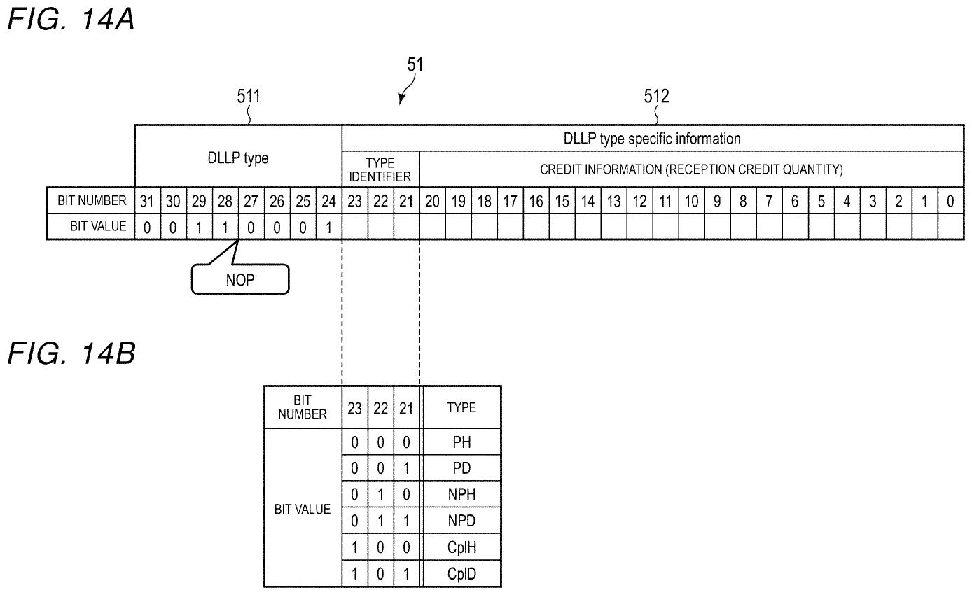

FIGS. 14A and 14B illustrate an example of one combination of a type identifier and credit information stored in the DLLP payload 51. As illustrated in FIG. 14A, the DLLP payload 51 includes the DLLP type 511 (bit string from bit #31 to bit #24) and the DLLP type specific information 512 (bit string from bit #23 to bit #0). A value “00110001” for designating NOP is stored (set) in the DLLP type 511.

In the DLLP type specific information 512, one type identifier and one piece of credit information corresponding to a type specified by the type identifier are stored. Specifically, the type identifier is stored as a bit string of 3 bits from bit #23 to bit #21. The bit string from bit #23 to bit #21 is referred to as a type bit string. The credit information is stored as a bit string of 21 bits from bit #20 to bit #0. The stored credit information can represent a reception credit quantity for the corresponding type in 2²¹ stages.

FIG. 14B illustrates an example of the type identifier set in the type bit string. The bit length of the type bit string is 3 bits. Therefore, the type bit string can represent up to eight types.

Specifically, for example, the type bit string “000” is a type identifier corresponding to PH. The type bit string “001” is a type identifier corresponding to PD. The type bit string “010” is a type identifier corresponding to NPH. The type bit string “011” is a type identifier corresponding to NPD. The type bit string “100” is a type identifier corresponding to CplH. The type bit string “101” is a type identifier corresponding to CplD.

A correspondence relationship between the type illustrated in FIG. 14B and the type identifier is an example. A format of credit information including any correspondence relationship between a type and a type identifier is, for example, shared in advance between the memory system 3 and the host 2. A method of sharing the format of the credit information has the same manner as described above in the first embodiment.

In each of the memory system 3 and the host 2, the packet generation unit 32 may be configured to store, for example, N combinations of type identifiers and pieces of credit information in the DLLP payload 51. Here, N is, for example, an integer of 1 or larger and smaller than a total number (for example, 6) of types of credits.

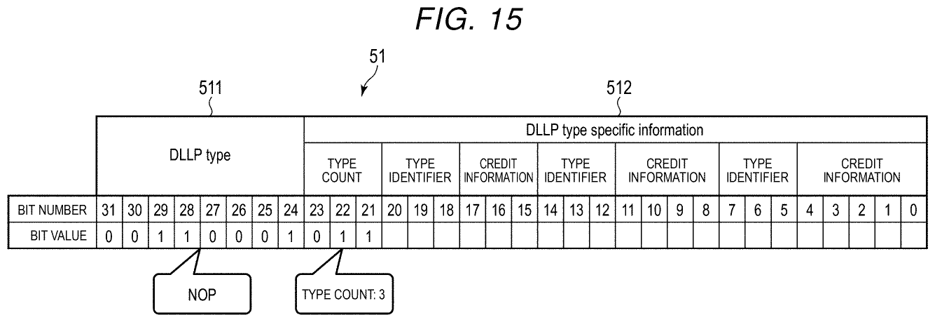

FIG. 15 illustrates an example of a type count N and N combinations of type identifiers and pieces of credit information, which are stored in the DLLP payload 51. The type count N is the number of types of credit information transmitted by using one DLLP payload 51. The DLLP type 511 is as described above with reference to FIGS. 14A and 14B.

The DLLP type specific information 512 stores the type count N and the N combinations of the type identifiers and the pieces of credit information.

Specifically, for example, the type count N is stored as a bit string from bit #23 to bit #21. For example, when the type count N is 3, “011” is stored as the bit string from bit #23 to bit #21.

In addition, a bit string from bit #20 to bit #0 is divided into N partial bit strings to store the N combinations of the type identifiers and the pieces of credit information. The bit length of the N partial bit strings may be the same or different. The N combinations of the type identifiers and the pieces of credit information are stored respectively in the N partial bit strings.

FIG. 15 illustrates a case where the type count N is 3 and the bit lengths of the N partial bit strings are different. The bit string from bit #20 to bit #0 is divided into three partial bit strings to store the three combinations of the type identifiers and the pieces of credit information. The three partial bit strings include a partial bit string from bit #20 to bit #15, a partial bit string from bit #14 to bit #8, and a partial bit string from bit #7 to bit #0.

The first combination of a type identifier and credit information is stored in the partial bit string from bit #20 to bit #15. More specifically, the type identifier of the first combination is stored as a bit string of 3 bits from bit #20 to bit #18. The credit information of the first combination is stored as a bit string of 3 bits from bit #17 to bit #15. In the credit information of the first combination, a reception credit quantity for the corresponding type can be represented in 8 (=2³) stages.

The second combination of a type identifier and credit information is stored in the partial bit string from bit #14 to bit #8. More specifically, the type identifier of the second combination is stored as a bit string of 3 bits from bit #14 to bit #12. The credit information of the second combination is stored as a bit string of 4 bits from bit #11 to bit #8. In the credit information of the second combination, a reception credit quantity for the corresponding type can be represented in 16 (=2⁴) stages.

The third combination of a type identifier and credit information is stored in the partial bit string from bit #7 to bit #0. More specifically, the type identifier of the third combination is stored as a bit string of 3 bits from bit #7 to bit #5. The credit information of the third combination is stored as a bit string of 5 bits from bit #4 to bit #0. In the credit information of the third combination, a reception credit quantity for the corresponding type can be represented in 32 (=2⁵) stages.

A correspondence relationship between the type identifier and the type is as described above with reference to FIG. 14B. In addition, a format of credit information including a correspondence relationship for each type between the value of a bit string stored as the credit information and the reception credit quantity (or a range including the reception credit quantity) is shared in advance between the memory system 3 and the host 2, for example. A method of sharing the format of the credit information has the same manner as described above in the first embodiment.

With the configuration of the DLLP payload 51 as illustrated in FIGS. 14A and 14B or FIG. 15, the Flit 8 including the DLLP payload 51 in which the N pieces of credit information are stored among the credit information for all types is transmitted between the memory system 3 and the host 2. In this case, each of the memory system 3 and the host 2 acquires the credit information for all types, by receiving a plurality of the Flits 8 each including the DLLP payload 51 in which the N pieces of credit information are stored. By storing the N pieces of credit information in one DLLP payload 51 instead of the credit information for all types, for example, the number of stages of the credit quantity that can be represented by each credit information may be increased.

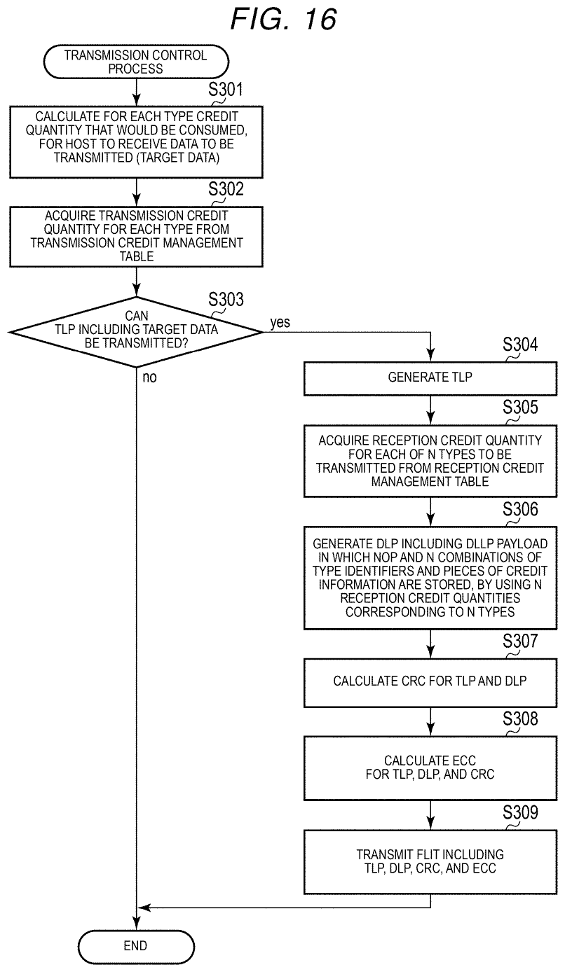

FIG. 16 is a flowchart illustrating an example of a procedure of a transmission control process executed in the memory system 3. The transmission control process is a process for transmitting the Flit 8 including credit information representing the current reception credit quantity corresponding to each of N types of credits to an external electronic device (here, the host 2). The host I/F 14 of the memory system 3 executes the transmission control process at a time at which the Flit 8 is to be transmitted. Here, it is assumed that NOP can be designated as a type of the DLLP in the DLLP payload 51 in the Flit 8 to be transmitted.

The transmission control process illustrated in FIG. 16 has the same manner as the transmission control process described above with reference to FIG. 11, except for a process of generating the DLP 82 in step S305 and step S306. That is, processes in steps S301 to S304 in the transmission control process in FIG. 16 and processes in steps S307 to S309 are the same as the processes in steps S101 to S104 in the transmission control process in FIG. 11 and the processes in steps S107 to S109. Therefore, only the processes in step S305 and step S306 will be described below.

The host I/F 14 acquires the reception credit quantity for each of the N types to be transmitted from the reception credit management table 351 (step S305). Specifically, the host I/F 14 acquires the N reception credit quantities respectively corresponding to the N types in, for example, PH, PD, NPH, NPD, CplH, and CplD from the reception credit management table 351. The host I/F 14 generates the DLP 82 including the DLLP payload 51 in which NOP and N combinations of type identifiers and pieces of credit information are stored, by using the acquired N reception credit quantities (step S306). More specifically, the host I/F 14 generates the DLLP payload 51 including (1) the DLLP type 511 in which NOP is designated and (2) the DLLP type specific information 512 in which the N combinations of the type identifiers and the pieces of credit information are stored.

With the above transmission control process, the host I/F 14 transmits the credit information representing the current reception credit quantity for each of the N types to the host 2 by using the DLLP payload 51 in the Flit 8. The host I/F 14 can transmit the credit information to the host 2 without a bandwidth of the link 7 being overloaded and without consuming extra resources, by using the DLLP payload 51, which is a partial region of the Flit 8. Therefore, the host I/F 14 can efficiently transmit the credit information to the host 2.

Further, in the same manner as in the transmission control process in FIG. 11, the transmission control process in FIG. 16 may also be executed by the storage I/F 23 of the host 2. Therefore, the host 2 can also achieve the same operation and effect as the memory system 3.

The reception control process has the same manner as the reception control process described above with reference to FIG. 13, except that N types of pieces of credit information are received instead of all types of credit information. In the reception control process in FIG. 13, step S208 of selecting the type (target type) of the credit is replaced with a process of specifying the target type based on the type identifier in the DLLP payload 51.

As described above, according to the first and second embodiments, information related to data transmission between electronic devices can be efficiently transmitted.

The host I/F 14 of the memory system 3 (or the storage I/F 23 of the host 2) executes communication between the memory system 3 and the host 2. The packet analysis unit 43 (more specifically, the TLP processing unit 433) of the host I/F 14 (or the storage I/F 23) stores data received from the host 2 (or the memory system 3) in a RAM (for example, the DRAM 5 or the RAM 22). The credit management unit 31 (or the credit management unit 41) manages a plurality of reception credit quantities respectively corresponding to a plurality of data types and each indicating a quantity of data of the corresponding data type that is currently receivable from the host 2 (or the memory system 3). The packet generation unit 32 and the packet transmission unit 33 transmit the Flit 8 including the credit information representing at least one reception credit quantity among the plurality of reception credit quantities, to the host 2 (or the memory system 3).

Therefore, the host I/F 14 (or the storage I/F 23) transmits the credit information representing the current reception credit quantity for at least one type to the host 2 (or the memory system 3) by using the Flit 8 (more specifically, the DLLP payload 51). By using a partial region of the Flit 8, the host I/F 14 (or the storage I/F 23) can transmit the credit information to the host 2 (or the memory system 3) without a bandwidth of the link 7 being overloaded and without consuming extra resources. Therefore, the host I/F 14 (or the storage I/F 23) can efficiently transmit the credit information to the host 2 (or the memory system 3).

The host I/F 14 of the memory system 3 (or the storage I/F 23 of the host 2) executes communication between the memory system 3 and the host 2. The packet analysis unit 43 (more specifically, the TLP processing unit 433) of the host I/F 14 (or the storage I/F 23) stores data received from the host 2 (or the memory system 3) in a RAM (for example, the DRAM 5 or the RAM 22). The credit management unit 31 (or the credit management unit 41) manages a plurality of transmission credit quantities respectively corresponding to a plurality of data types and each indicating a quantity of data of the corresponding data type that is currently transmissible to the host 2 (or the memory system 3), and receives the Flit 8 including the credit information from the host 2 (or the memory system 3). The credit information represents a reception credit quantity, and the reception credit quantity corresponds to one data type among the plurality of data types and indicates a quantity of data of the one data type that is currently receivable by the host 2 (or the memory system 3). The packet analysis unit 43 compares the transmission credit quantity corresponding to the one data type with the credit information.

Therefore, the host I/F 14 (or the storage I/F 23) receives the Flit 8 (more specifically, the DLLP payload 51) including the credit information for each type from the host 2 (or the memory system 3). The host I/F 14 (or the storage I/F 23) can check whether the transmission credit quantity for each type (that is, the reception credit quantity for each type in the host 2 (or the memory system 3)) is correctly managed in the transmission credit management table 352 (or the transmission credit management table 452) by using the credit information for each type, for example, for the host 2 (or the memory system 3).

The packet generation unit 32 of the memory system 3 (or the host 2) manages a first quantity (for example, a reception credit quantity) indicating a state of an internal resource of the memory system 3 (or the host 2), and transmits a first packet (for example, InitFC) indicating an initial value of the first quantity, a second packet (for example, UpdateFC) indicating an increase value or a decrease value of the first quantity, and a third packet (for example, the Flit 8) indicating a current value of the first quantity, to the host 2 (or the memory system 3) via the packet transmission unit 33.

Therefore, the storage I/F 23 of the host 2 (or the host I/F 14 of the memory system 3) can check whether the first quantity in the memory system 3 (or the host 2) is correctly transmitted, by the first packet, the second packet, and the third packet.

Each of the various functions described in the first and second embodiments may be implemented by circuits (processing circuits). Examples of the processing circuit include a programmed processor such as a central processing unit (CPU). The processor executes each of the described functions by executing computer programs (instruction group) stored in a memory. The processor may be a microprocessor that includes an electrical circuit. Examples of the processing circuit also include digital signal processors (DSPs), application specific integrated circuits (ASICs), microcontrollers, controllers, and other electrical circuit components. Each of the components other than the CPU described in these embodiments may also be implemented by the processing circuit.

While certain embodiments have been described, these embodiments have been presented by way of example only, and are not intended to limit the scope of the disclosure. Indeed, the novel embodiments described herein may be embodied in a variety of other forms; furthermore, various omissions, substitutions, and changes in the form of the embodiments described herein may be made without departing from the spirit of the disclosure. The accompanying claims and their equivalents are intended to cover such forms or modifications as would fall within the scope and spirit of the disclosure.

What is claimed is:

1. An electronic device comprising:
a random access memory; and
an interface circuit configured to:
execute communication between the electronic device and an external electronic device; and
store data received from the external electronic device in the random access memory,
wherein the interface circuit is further configured to:
manage a plurality of credit quantities respectively corresponding to a plurality of data types and each indicating a quantity of data of a corresponding data type that is currently receivable from the external electronic device; and
transmit a first packet including credit information representing at least one credit quantity among the plurality of credit quantities, to the external electronic device.

2. The electronic device according to claim 1, wherein the interface circuit is configured to transmit the first packet including a plurality of pieces of credit information respectively representing the plurality of credit quantities, to the external electronic device.

3. The electronic device according to claim 2, wherein
the first packet is a flow control unit packet defined in a PCI Express standard,
the flow control unit packet includes a data link layer packet, and
the interface circuit is configured to respectively store the plurality of pieces of credit information in a plurality of first data sections of the data link layer packet.

4. The electronic device according to claim 1, wherein
the interface circuit is configured to transmit the first packet further including a data type identifier indicating one of the plurality of data types and the credit information representing one credit quantity among the plurality of credit quantities corresponding to the one of the plurality of data types, to the external electronic device.

5. The electronic device according to claim 4, wherein
the first packet is a flow control unit packet defined in a PCI Express standard,
the flow control unit packet includes a data link layer packet, and
the interface circuit is further configured to:
store the data type identifier in a second data section of the data link layer packet; and
store the credit information in a third data section of the data link layer packet.

6. The electronic device according to claim 5, wherein the interface circuit is further configured to store data indicating a type of a specific data link layer packet in a fourth data section of the data link layer packet.

7. The electronic device according to claim 6, wherein the type of the specific data link layer packet is no operation (NOP) defined in the PCI Express standard.

8. The electronic device according to claim 1, wherein the plurality of data types include Posted Request headers (PH), Posted Request Data payload (PD), Non-Posted Request headers (NPH), Non-Posted Request Data payload (NPD), Completion headers (CplH), and Completion Data payload (CplD), all of which are defined in a PCI Express standard.

9. The electronic device according to claim 1, wherein each of the plurality of credit quantities indicates a quantity of data of the corresponding data type that is currently receivable from the external electronic device, with the number of data units according to the corresponding data type.

10. An electronic device comprising:
a random access memory; and
an interface circuit that is configured to:
execute communication between the electronic device and an external electronic device; and
store data received from the external electronic device in the random access memory,
wherein the interface circuit is further configured to:
manage a plurality of first credit quantities respectively corresponding to a plurality of data types and each indicating a quantity of data of a corresponding data type that is currently transmissible to the external electronic device;
receive a first packet including credit information representing a second credit quantity from the external electronic device, the second credit quantity corresponding to one data type among the plurality of data types and indicating a quantity of data of the one data type that is currently receivable by the external electronic device; and
compare the first credit quantity corresponding to the one data type with the credit information.

11. The electronic device according to claim 10, wherein the interface circuit is further configured to output an error when the first credit quantity corresponding to the one data type does not match a number specified in the credit information or fall within a range specified in the credit information.

12. The electronic device according to claim 10, wherein
the first packet includes a plurality of pieces of credit information respectively representing a plurality of the second credit quantities, and the plurality of second credit quantities respectively correspond to the plurality of data types and each of the plurality of second credit quantities indicates a quantity of data of a corresponding data type that is currently receivable by the external electronic device, and
the interface circuit is configured to compare the first credit quantity corresponding to the one data type with credit information corresponding to the one data type among the plurality of pieces of credit information.

13. The electronic device according to claim 12, wherein
the first packet is a flow control unit packet defined in a PCI Express standard,
the flow control unit packet includes a data link layer packet, and
the interface circuit is configured to respectively acquire the plurality of pieces of credit information from a plurality of first data sections of the data link layer packet.

14. The electronic device according to claim 10, wherein
the first packet further includes a data type identifier indicating the one data type, and
the interface circuit is configured to compare the first credit quantity corresponding to the one data type with the credit information, based on the data type identifier.

15. The electronic device according to claim 14, wherein
the first packet is a flow control unit packet defined in a PCI Express standard,
the flow control unit packet includes a data link layer packet, and
the interface circuit is configured to:
acquire the data type identifier from a second data section of the data link layer packet; and
acquire the credit information from a third data section of the data link layer packet.

16. The electronic device according to claim 15, wherein the interface circuit is further configured to acquire data indicating a type of a specific data link layer packet from a fourth data section of the data link layer packet.

17. The electronic device according to claim 16, wherein the type of the specific data link layer packet is no operation (NOP) defined in the PCI Express standard.

18. The electronic device according to claim 10, wherein the plurality of data types include Posted Request headers (PH), Posted Request Data payload (PD), Non-Posted Request headers (NPH), Non-Posted Request Data payload (NPD), Completion headers (CplH), and Completion Data payload (CplD), all of which are defined in a PCI Express standard.

19. The electronic device according to claim 10, wherein
each of the plurality of first credit quantities indicates a quantity of data of the corresponding data type that is currently transmissible to the external electronic device, with the number of data units according to the corresponding data type, and
the second credit quantity indicates a quantity of data of the one data type that is currently receivable by the external electronic device, with the number of data units according to the one data type.

20. An electronic device comprising:
an interface circuit; and
a control circuit,
wherein the control circuit is configured to:
manage a first quantity indicating a state of an internal resource of the electronic device; and
transmit a first packet indicating an initial value of the first quantity, a second packet indicating an increase value or a decrease value of the first quantity, and a third packet indicating a current value of the first quantity, via the interface circuit.
